(19) United States
(12) Patent Application Publication
(10) Pub. No.: US 2011/0140366 A1
(43) Pub. Date: Jun. 16, 2011

(54) IMPROVEMENTS IN AND RELATING TO SPRING ENERGISED PLASTIC SEALS

(75) Inventor: Christian Kirchner, Dortmund (DE)

(73) Assignee: John Crane UK Limited, Slough (GB)

(21) Appl. No.: 13/058,507

(22) PCT Filed: Aug. 7, 2009
(86) PCT No.: PCT/GB09/01942

§ 371 Date: Feb. 10, 2011

(30) Foreign Application Priority Data
Aug. 11, 2008 (GB) 0814616.9

(51) Int. Cl. F16J 15/34

(52) U.S. Cl. 277/377

(57) ABSTRACT

A seal assembly for providing a seal between a pair of components has a sealing ring made of flexible plastics material and a backup ring (70) made of resiliently flexible plastics material being located coaxially of the sealing ring on the side thereof remote from the limbs, the backup ring abutting a f rusto-conical surface (62) of a base of the sealing ring, said frusto-conical surface engaging a corresponding frusto-conical surface (74) of the backup ring, to apply a radial load to the inner periphery of the backup ring urging it towards the outer periphery of the inner component, when an axial load is applied to the sealing ring by exposure of the sealing ring to pressure from the side of the sealing ring to which the limbs extend, a projection (72) on the backup ring engaging an inner periphery of an axially extending annular recess (80) in the outer component, to locate and support the reinforcing ring radially.

The present invention relates to spring energised plastic seals.

In accordance with one aspect of the present invention, a seal assembly for providing a seal between a pair of components comprises a sealing ring made of flexible plastics material which is located coaxially between the components, the sealing ring being of channel section having a pair of limbs extending axially to one side of the sealing ring, the inner periphery of the inner limb forming a sealing element for engagement of a surface of said component mounted internally of the sealing ring, spring means acting on the external periphery of the inner limb to resiliently load the sealing element into sealing engagement with the surface of the inner component, a rigid ring abutting the internal periphery of the outer limb of the sealing ring, to compress the outer limb into sealing engagement with a surface of the component mounted externally of the sealing ring; and a backup ring made of resiliently flexible plastics material being located coaxially of the sealing ring on the side thereof remote from the limbs, the backup ring having an portion of increased internal diameter at an end remote from the base of the channel section of the sealing ring, the backup ring abutting a frusto-conical surface of the base of the sealing ring, said frusto-conical surface extending from the internal diameter away from the limbs of the sealing ring and engaging a corresponding frusto-conical surface of the backup ring, to apply a radial load to the inner periphery of the backup ring urging it towards the outer periphery of the inner component, when an axial load is applied to the sealing ring by exposure of the sealing ring to pressure from the side of the sealing ring to which the limbs extend, the projection on the backup ring engaging an inner periphery of an axially extending annular recess in the outer component, to locate and support the reinforcing ring radially.

In accordance with the present invention, when the seal is pressurised from the side to which the limbs extend, the limbs will be urged outwardly to increase the seal provided between the sealing element on the inner limb and the surface of the inner component. The axial load applied to the sealing ring will also urge the inner periphery of the backup ring inwardly, closing the gap between the backup ring and surface if the inner component and preventing extrusion of the inner limb of the sealing ring through the gap. The backup ring is supported radially by engagement of the inner periphery of the portion of increased internal diameter with the internal periphery of the annular recess in the outer component, to prevent the backup ring from buckling and being extruded into the gap between the inner and outer components.

The invention is now described, by way of example only, with reference to

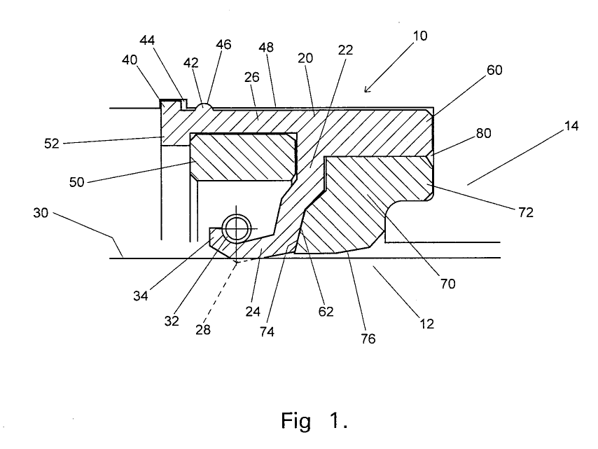

FIG. 1 which shows a part sectional side elevation of a seal in accordance with the present invention.

FIG. 1 shows seal assembly 10 for providing a secondary seal between a carrier ring 12 of a mechanical face seal and a housing 14, the carrier ring 12 being slidably mounted with respect to the housing, in know manner.

The seal assembly 10 comprises a polymeric sealing ring 20 made of, for example PTFE. The sealing ring 20 has an axially extending channel portion having a radially extending base 22 and a pair of radially separated axially extending limbs 24, 26. The inner limb 24 has an annular seal formation 28 on its inner periphery which is urged into sealing engagement with a cylindrical outer surface 30 of the carrier ring 12, by means of a garter spring 32. The garter spring 32 acts on the outer periphery of limb 24 radially outwardly of the seal formation 26 and is located in position by means of a radially outwardly extending flange formation 34 at the free end of limb 24.

A radially outwardly extending flange formation 40 is provided at the free end of the outer limb 26 and an annular rib formation 42 is provided in the outer periphery of limb 26, adjacent the flange formation 40. The flange formation 40 and rib 42 engage in corresponding annular recesses 44, 46 respectively, in a cylindrical surface 48 of the housing 14. A metal ring 50 is located in the channel section of ring 20, the metal ring engaging the inner periphery of limb 26 and compressing the limb 26 against cylindrical surface 48, to form a seal against the cylindrical surface 48. The metal ring 50 is located in the channel section by means of a flange formation 52 which extends radially inwardly from the free end of limb 26.

An annular projection 60 extends axially to the side of the base 22 opposite to the channel section of sealing ring 20, about its outer periphery. Internally of the annular projection 60, the end face of the base 22 remote from limbs 24, 26 has a frusto-conical surface 62 which is inclined from the internal diameter of the sealing ring 20 away from the limbs 24, 26.

A back-up ring 70 made of flexible plastics material, is mounted internally of the annular projection 60, the end portion 72 of the back-up ring 70 remote from the base 22 of the channel portion of sealing ring 20 is of enlarged internal diameter. The face of the backup ring 70 adjacent the base 22 of the channel section of sealing ring 20 has a frusto-conical surface 74 corresponding to and engaging the frusto-conical surface 62 of the sealing ring 20. The inner periphery 76 of the smaller internal diameter portion of back-up ring 70 remote from the sealing ring 20 is tapered outwardly.

The projection 60 and larger internal diameter portion 72 of backup ring 70 are located in an axially extending recess 80 in the housing 14, which serves to locate the sealing ring 20, the back-up ring 70 and the carrier ring 12 axially of the housing 14.

In operation, the seal assembly is mounted between the housing 14 and carrier ring 12, with the channel section opening towards the pressure side of the mechanical face seal. The pressure of the service fluid will consequently urge the inner limb 24 inwardly to reinforce the radial load applied by the garter spring 32 and ensure the seal with the carrier ring 12. Furthermore, the axial load applied by the fluid pressure will force the frusto-conical surface 62 of the sealing ring 20 against frusto-conical surface 74 of back-up ring 70, applying a radial load to the back-up ring 70 causing it to deform and close the gap with the cylindrical surface of the carrier ring 12 and preventing extrusion of the limb 24 through the gap between the housing 14 and carrier ring 12. Engagement of the inner periphery of the larger diameter portion 72 of backup ring 70 with the inner periphery of recess 80 will prevent the back-up ring 70 from buckling and being extruded into the gap between the housing 14 and carrier ring 12, under the load applied by the sealing ring.

The metal ring 50 will also accommodate thermal growth differentials at the outer diameter of the seal ring 20.

1. A seal assembly for providing a seal between a pair of components comprising a sealing ring made of flexible plastics material which is located coaxially between the components, the sealing ring being of channel section having a pair of limbs extending axially to one side of the sealing ring, the inner periphery of the inner limb forming a sealing element for engagement of a surface of said component mounted internally of the sealing ring, spring means acting on the external periphery of the inner limb to resiliently load the sealing element into sealing engagement with the surface of the inner component, a rigid ring abutting the internal periphery of the outer limb of the sealing ring, to compress the outer limb into sealing engagement with a surface of the component mounted externally of the sealing ring; and a backup ring made of resiliently flexible plastics material being located coaxially of the sealing ring on the side thereof remote from the limbs, the backup ring having an portion of increased internal diameter at an end remote from the base of the channel section of the sealing ring, the backup ring abutting a frusto-conical surface of the base of the sealing ring, said frusto-conical surface extending from the internal diameter away from the limbs of the sealing ring and engaging a corresponding frusto-conical surface of the backup ring, to apply a radial load to the inner periphery of the backup ring urging it towards the outer periphery of the inner component, when an axial load is applied to the sealing ring by exposure of the sealing ring to pressure from the side of the sealing ring to which the limbs extend, the projection on the back-up ring engaging an inner periphery of an axially extending annular recess in the outer component, to locate and support the back-up ring radially.

2. A seal assembly according to claim 1 in which an axial annular projection extends from the base of the channel section of the seal ring on the side thereof remote from the limbs, the annular projection being radially outwardly of the frusto-conical surface of the base of the sealing ring and engaging an outer peripheral surface of the back-up ring.

3. A seal assembly according to claim 1 in which the seal ring is made of a low friction polymeric material.

4. A seal assembly according to claim 3 in which the seal ring is made of PTFE.

5. A seal assembly according to claim 1 in which the inner limb of the seal ring has an annular seal formation on its inner periphery, the annular seal formation being adjacent a free end of the inner limb.

6. A seal assembly according to claim 1 in which a garter spring acts in the external periphery of the inner limb of the seal ring to resiliently load the inner limb into sealing engagement with the inner component.

7. A seal assembly according to claim 1 in which the rigid ring is made of metal.

8. (canceled)

9. A seal assembly according to claim 2 in which the seal ring is made of a low friction polymeric material.
